(19) United States
(12) Patent Application Publication
(10) Pub. No.: US 2008/0105631 A1
(43) Pub. Date: May 8, 2008

(54) SHELVING DISPLAY

(76) Inventor: Karen Sutter, Appleton, WI (US)

Correspondence Address: GODFREY & KAHN S.C., 780 NORTH WATER STREET, MILWAUKEE, WI, 53202, US

(21) Appl. No.: 11/557,723

(22) Filed: Nov. 8, 2006

(51) Int. Cl. B42F 17/18

(52) U.S. Cl. 211/10

(57) ABSTRACT

The shelving display that comprises a box, at least one shelf member, and at least two locking devices to secure the shelf member(s) to the box. The box consists of a top, a bottom, and at least two sides, where at least two of the sides have slots that are substantially matching with each other. The shelf member(s), which is distinct from the box, has at least two tabs, each tab capable of being passed through a slot on the side of the box, thereby connecting the shelf member to the box. Each of the tabs on the shelf member has an opening which is positioned substantially outside the box when the tab is passed through the respective slot on the side of the box. The locking device is passed through the opening of these tabs, securing the shelf member(s) to one side of the box.

### BACKGROUND OF THE INVENTION

The present invention relates generally to shelving for the storage and display of products and more particularly to shelving that is fabricated from a lightweight material and is easily assembled and securely constructed for the storage and display of sheet products.

In informal sales settings, there is a need to store and display sheet products. The nature of this type of product and the sales environment present unique challenges. Regarding the nature of the product, sheet product varies in size and thickness. Therefore, shelving for sheet product should be configurable and stable, reducing the risk of damage to this pliable product. Regarding the nature of the sales environment, informal craft shows and similar events are typically short term events, calling for the quick set-up and take-down of display shelving. An overly complicated design or one fabricated from expensive components is not warranted.

Shelving fabricated from a relatively lightweight material, such as paper, paperboard, or corrugated materials, is well-known. This type of shelving has two primary advantages. First, the lightweight construction facilitates the assembly and movement of the shelving, promoting re-use. Second, a lightweight material often translates to lower manufacturing and shipping costs.

However, shelving constructed from a lightweight material can suffer from reduced structural strength and be prone to damage. Shelving supported by a narrow base can be easily tipped, potentially damaging both the shelving and the product. In addition, shelves that are separate and distinct from the overall structure are prone to slipping from their desired position, if not locked into place.

Although shelving fabricated from lightweight materials is well-known, shelving to both store and display sheet product is not. Display shelving, especially that suitable for sheet product, tends not to maximize the use of the available space, a concern when storing product. In the prior art, the display shelving includes shelf support members or walls around the perimeter of the shelves. Shelf support members and perimeter walls consume space below and above the shelf, respectively, which could be used for storage. As for storage shelving in the prior art, especially that suitable for sheet product, the designs tend to resemble filing drawers or the like. In these designs, the sheets are stored vertically, exposing just one edge and thus limiting the display of the sheet product.

Accordingly, a need exists for shelving that is lightweight, easy to assemble, securely holds the product, and can both store and display sheet product, in particular.

### SUMMARY OF THE INVENTION

The invention provides a shelving display comprising a box, at least one shelf member, and at least two locking devices to secure the shelf members to the box. The box has a top, a bottom, and at least two sides, where at least two of the sides have slots that are substantially matching with each other. Each shelf member, which is distinct from the box, has at least two tabs, each tab capable of being passed through one of the slots, and thereby being connected to the sides of the box. Each of the tabs on the shelf member has an opening which is positioned substantially outside the box when the tab is passed through the respective slot. A locking device is passed through each opening of the tabs, securing the shelf member(s) to the respective side of the box.

The purpose of the shelving display is to store and display sheet product. The shelving display is fabricated from a lightweight and inexpensive material such as paper, paperboard, corrugated materials, plastics and combinations thereof. Each shelf member for the shelving display is removable from and connectable to at least two sides of the display shelving box. The slots formed in the sides are slanted, so that each shelf member rests at a slight downward slope from the back to the front of the box. The front edge of the shelf member is provided with an upright flap to hold the articles supported by the shelf member in place. The locking device for the shelving display is shaped like a T-bar, such that a section of one end of the device is substantially wider than the remainder of the device, preventing the entire device from passing through all shelf member tabs that protrude from the one side of the box.

Other objects and advantages of the invention will become apparent hereinafter.

### BRIEF DESCRIPTION OF THE DRAWINGS

FIG. 1 is a perspective view of a shelving display according to one embodiment of the present invention.

FIG. 2 is a front perspective view of the shelving display of FIG. 1.

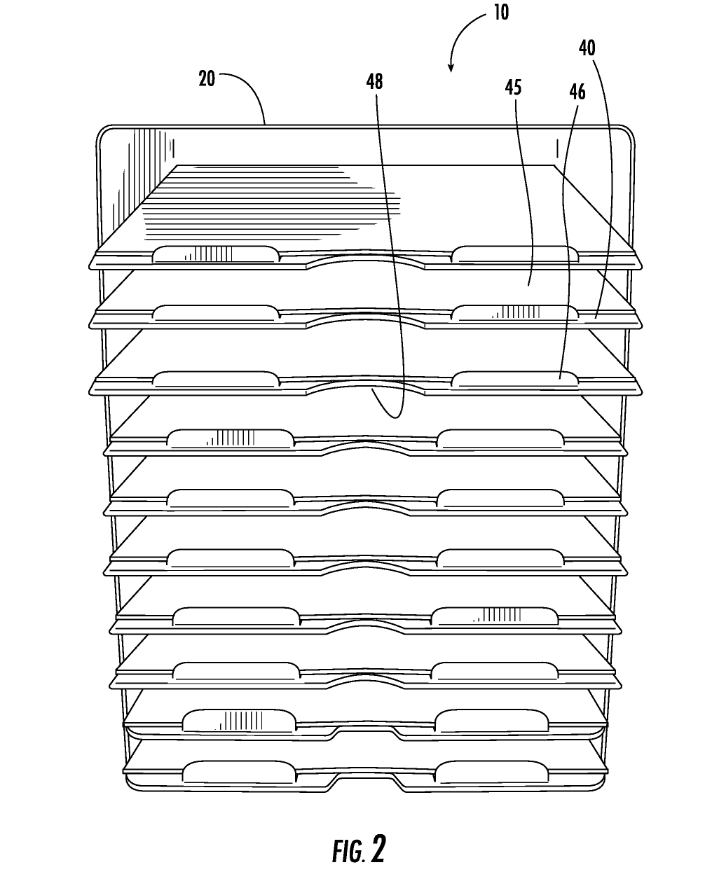

FIG. 3 is a side perspective view of the shelving display of FIGS. 1-2.

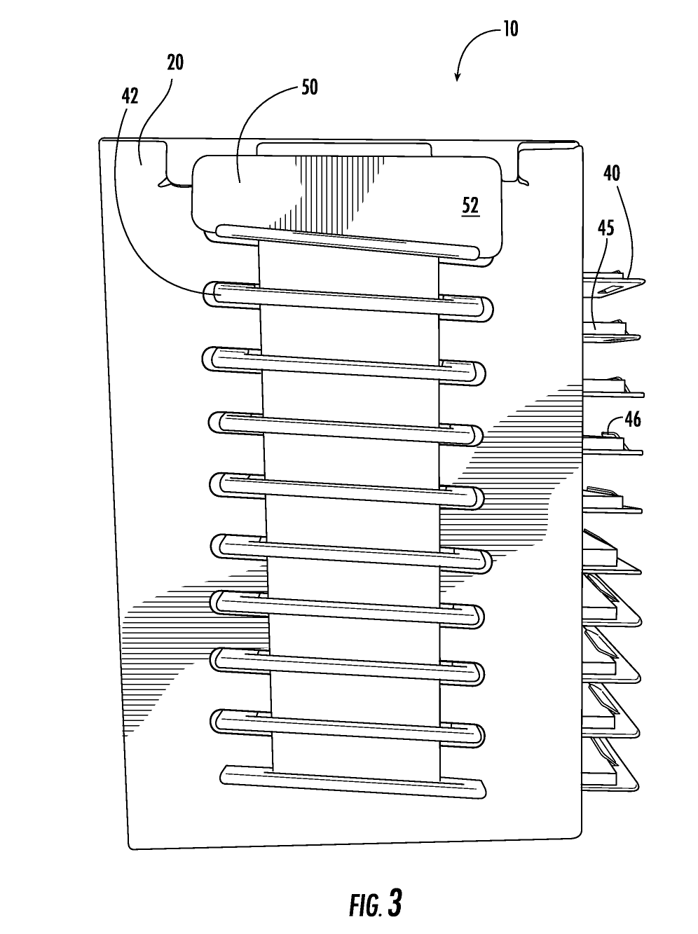

FIG. 4 is a plan view of the blank for the box for the shelving display, according to the embodiment of FIGS. 1-3.

FIG. 5 is a plan view of a shelf member for the shelving display, according to the embodiment of FIGS. 1-4.

FIG. 6 is a plan view of a locking device for the shelving display, according to the embodiment of FIGS. 1-5.

### DETAILED DESCRIPTION

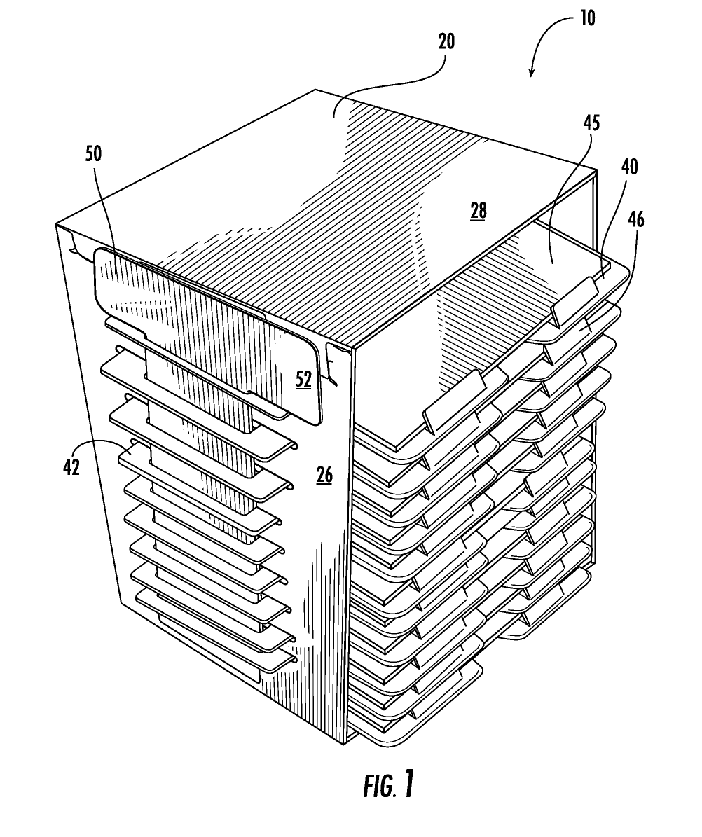

Referring now to FIG. 1, a shelving display 10 according to the present invention is an article of manufacture that may be easily assembled and securely configured to create a desired storage and display for sheet product. The shelving display 10 preferably incorporates an outer shell, i.e., box 20, at least one shelving member 40, and two locking devices 50 for the storage and display of product 45. Box 20 can be formed of a top 28, a bottom 30, and at least two side panels 26, where the side panels support the top panel and the shelf members 40. A backside 24 may also be provided. At least two of the three sides 24, 26 include at least one slot 32 each. Each slot 32 preferably slopes slightly forward, so that when shelf member 40 is mounted, the shelf member tilts slightly forward toward its front edge.

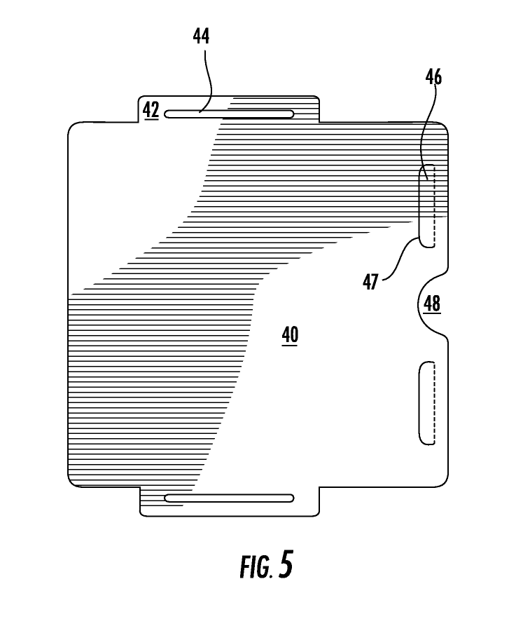

FIG. 5 illustrates shelving member 40 as viewed from the top. Shelving member 40 is mounted to the two sides of box 20 to create a surface for displaying the sheet product. Shelving member 40 includes two tabs 42, one tab extending from each side of the shelving member. To mount shelving member 40, the tabs 42 are passed through the corresponding slots 32 located on each of at least two of sides 24, 26 of box 20. Each tab 42 includes a cross-slot 44 which, when shelving member 40 is mounted, lies outside of box 20, generally parallel to side 26.

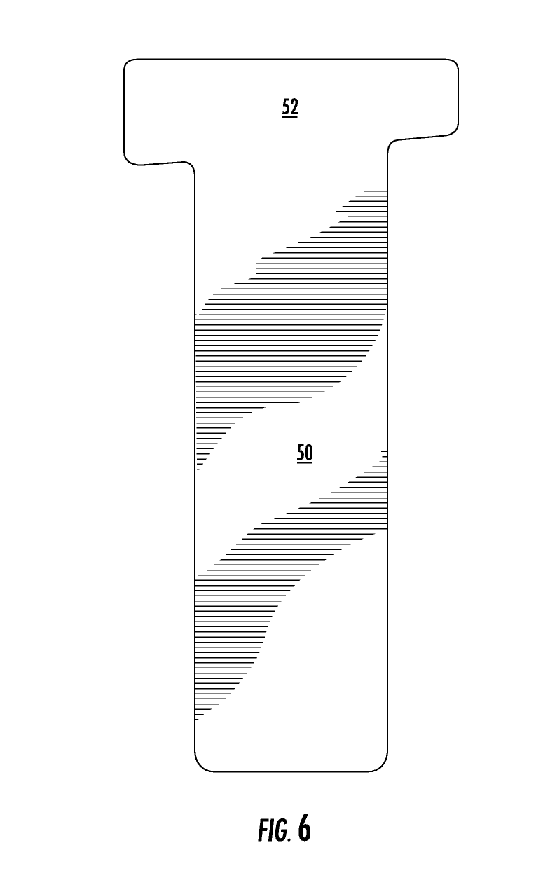

FIG. 6 illustrates locking device 50, substantially a long, flat and thin member, as viewed in plan view. After all shelving members 40 are mounted in box 20, with the tabs 42 from the shelving member extending through the slots 32 sufficiently so that the respective cross-slot 44 is outside the box 20, the locking device 50 is extended or inserted through the cross-slots. Locking device 50 is used to secure the shelving members in place and provide added stability to box 20. In the most preferred embodiment, locking device 50 resembles a T-bar, with a portion of one end of the device, protrusion 52, substantially wider than the remainder. Protrusion 52 acts as a stop, preventing locking device 50 from completely passing through cross-slots 44.

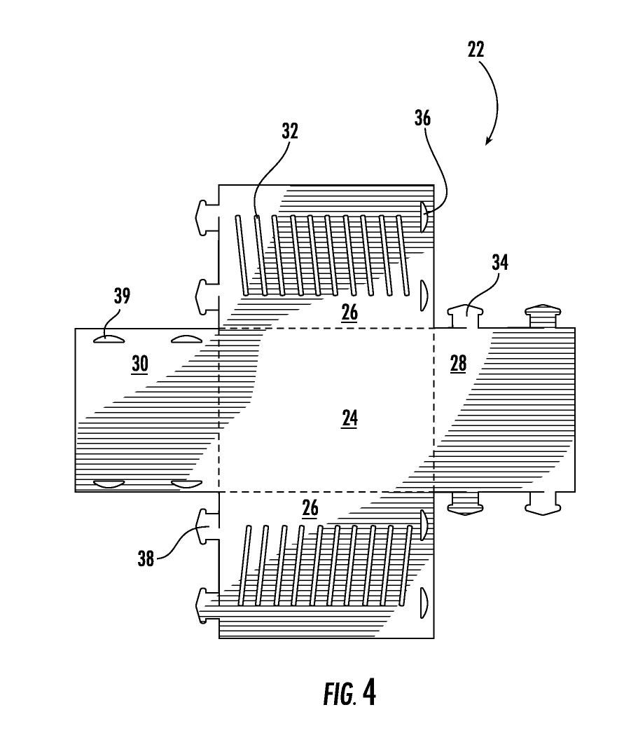

In the preferred embodiment, box 20 of the shelving display is formed by configuring a blank 22, as shown in FIG. 4, viewed in plan view from its rear side. Blank 22 includes five panels, a center panel that is backside 24 (i.e. back wall) of box 20 and the following four panels that are adjacent to the center panel: two sides 26, top 28, and bottom 30 of box 20. Blank 22 also includes at least one slot 32 cut from each of the two sides 26 representing the position where a shelf member 40 may be mounted to each side. While blank 22 is shown configured for providing locations for up to ten shelf members, a greater or lesser number of slots 32 may be provided, if desired, by altering blank 22 to accommodate a greater or lesser number of shelf members 40.

To form box 20, the two sides 26, top 28 and bottom 30 are folded perpendicular along their border with backside 24. Tabs 34 extending from top 28 are folded perpendicular and inserted into the corresponding slots 36 on sides 26 to secure top 28 to sides 26. To secure bottom 30 to sides 26, tabs 38 that extend from sides 26 are inserted into the corresponding slots 39 cut from bottom 30 and folded perpendicular, in line with bottom 30.

Shelving member 40 is designed to secure product 45 and to provide easy access to it. To secure the product, shelving member 40 includes one or more upstanding tabs 46 located near the front edge of the shelving member. The upstanding tabs 46 prevent the sheet product stored on shelving member 40 from sliding off. In the preferred embodiment, the upstanding tabs 46 are formed integrally with the shelving member 40, by means of a curved partial punch or cut line 47, formed with its endpoints nearest the front edge of the shelving member and the center further away. Each upstanding tab 46 is then simply folded upward along the line formed by the two endpoints of the cut line 47.

To provide easy access to the sheet product, especially in configurations with multiple shelving members and minimal space between adjacent shelving members, the front edge of shelving member 40 includes a cut-out or opening 48, shown with a concave curved cut line 49 in the most preferred embodiment. Opening 48 provides extra space to view, access, and obtain a sheet of product from the shelving member immediately below.

While this invention is susceptible of embodiment in many different forms, the above description discloses a specific embodiment, with the understanding that the present invention is to be considered as an exemplification of the principles of the invention and is not intended to limit the invention to the embodiment illustrated, but rather is determined entirely by reference to the following claims.

What is claimed is:

1. A shelving display comprising:
a box, having a top, a bottom, a back, a left side and a right side, said left and right sides having slots that are substantially matching with each other and opposed to each other;
at least one shelf member distinct from said box, and having at least two tabs, each capable of being passed through said opposing slots and thereby being connected to each of the two sides of the box;
each of the tabs having an opening which is positioned substantially outside the box when the tab is passed through the respective slot; and
a locking device capable of being passed through the opening of the tabs.

2. The shelving display according to claim 1 wherein the at least one shelf member is removable from and connectable to the left and right sides.

3. The shelving display according to claim 1 wherein the at least one shelf member rests at a slight downward slope from the back to the front of the box, and the front edge of said shelf member has an upright flap to hold the articles supported by said shelf member in place.

4. The shelving display according to claim 1 wherein the locking device for the left and right sides is shaped like a T-bar, such that a fraction of one end of the device is substantially wider than the remainder of the device, preventing the entire device from completely passing through all tabs.

5. The shelving display according to claim 1 wherein the display is fabricated from a lightweight material selected from the group consisting of paper, paperboard, corrugated materials, and plastic and combinations thereof.

6. A shelving display comprising:
a box, having a top, a bottom, and at least two sides, at least two of said sides having slots that are substantially matching with each other;
at least one shelf member distinct from said box, and having at least two tabs, each tab capable of being passed through one of said slots and thereby being connected to each of two sides of the box;
each of the tabs having an opening which is positioned substantially outside the box when the tab is passed through the respective slot; and
a locking device capable of being passed through the opening of the tabs.

7. The shelving display according to claim 6 wherein the at least one shelf member is removable from and connectable to two sides.

8. The shelving display according to claim 6 wherein the at least one shelf member rests at a slight downward slope from the back to the front of the box and the front edge of said shelf member has an upright flap to hold the articles supported by said shelf member in place.

9. The shelving display according to claim 6 wherein the locking device is shaped like a t-bar, such that a fraction of one end of the device is substantially wider than the remainder of the device, preventing the entire device from completely passing through all tabs.

10. The shelving display according to claim 6 wherein the display is fabricated from a lightweight material selected from the group consisting of paper, paperboard, corrugated materials, and plastic and combinations thereof.

11. A shelving display for the storage and display of sheet product, comprising:
a box, having a top, a bottom, and at least two sides, at least two of said sides having slots that are substantially matching with each other;
at least one shelf member distinct from said box, having at least two tabs where each tab is capable of being passed through one of said slots and thereby being connected to each of two sides of the box, having at least one upright flap located near the front edge of the shelf member to hold articles supported by said shelf member in place;
said slots having a slight downward slope from the back to the front of said box so that the at least one shelf member has a slight downward slope from the back to the front when connected to said box;
each of the tabs having an opening which is positioned substantially outside the box when the tab is passed through the respective slot; and
a locking device capable of being passed through the opening of the tabs, said locking device shaped like a T-bar, such that a fraction of one end of the device is wider than the largest dimension of the opening of the tabs, preventing the entire device from completely passing though the tabs.

12. A shelving display according to claim 11 wherein the box and the shelf member are fabricated from a lightweight material selected from the group consisting of paper, paperboard, corrugated materials, and plastic and combinations thereof.
